(19) United States
(12) Patent Application Publication
(10) Pub. No.: US 2006/0124695 A1
(43) Pub. Date: Jun. 15, 2006

(54) Stable liquid preparation

(75) Inventors: Yoichi Ikeda, Hiroshima (JP); Soko Motoune, Hiroshima (JP); Mizuho Ono, Hiroshima (JP); Yoshifumi Mohri, Hiroshima (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: WAKUNAGA PHARMACEUTICAL CO., LTD., Osaka-shi (JP)

(21) Appl. No.: 10/559,778

(22) PCT Filed: Jun. 25, 2004
(86) PCT No.: PCT/JP04/08990

§ 371 Date: Dec. 7, 2005

(30) Foreign Application Priority Data
Jun. 27, 2003 (JP) 2003-184881

(51) Int. Cl. A47J 36/02

(52) U.S. Cl. 228/101

(57) ABSTRACT

This invention relates to a liquid preparation containing a solution, which has a water content of from 10 to 80%, and an active ingredient coated with a coating material comprising a water-soluble cellulose derivative. The liquid preparation can stably retain the water-unstable active ingredient in it and at the same time, can mask its unpleasant taste and/or smell, and is usable as drug, quasi-drug, cosmetic, food or the like.

### TECHNICAL FIELD

This invention relates to stable liquid preparations useful as drug, quasi-drug, cosmetics or foods, and also to a method for stabilizing active ingredients in liquid preparations.

### BACKGROUND ART

A liquid preparation is used as a preparation form such that upon taking an active ingredient in the field of medicines or foods, its compliance can be improved and its absorption can be accelerated.

A liquid preparation for internal use is usually prepared by dissolving a crude drug, a water-soluble pharmaceutical or the like as an active ingredient in water, optionally along with one or more water-soluble additives such as corrigents, colorants and flavorings. Such liquid preparations for internal use can be generally categorized into syrups and so-called health drinks. The former contain sugar at high concentration and are thick and viscous, while the latter are low in sugar concentration. Irrespective of the category, water is contained approximately at from 30% to 90% or so, so that with water-unstable ingredients, liquid preparations for internal use include those incapable of securing storage stability. Further, ingredients dissolved in an aqueous solution are dispersed in the form of molecules, and therefore, each active ingredient degrades under the influence of molecules of the other ingredients, thereby causing a deterioration in the quality of the liquid preparation. Moreover, with a liquid preparation, a stronger taste is felt than with a solid preparation. The formulation of an ingredient having bitterness or a sharp taste into a liquid preparation, therefore, may require the addition of additives such as a corrigent and sweetener at high concentrations, or may be infeasible because the ingredient is not suited for internally taking the same.

For the incorporation of a water-unstable ingredient or an ingredient having an unpleasant flavor in a liquid preparation, conventionally-known techniques include, for example, controlling the pH of a crude-drug-containing liquid preparation to from 2.2 to 3.8 with a view to achieving its stabilization (see, for example, Patent Document 1) or adjusting the ionic strength of a crude-drug-containing liquid preparation, and adding cyclodextrin as a stabilizer to a vitamin-B1-containing liquid preparation (see, for example, Patent Document 2). In addition, methods of securing stability by forming an active ingredient into a w/o/w emulsion (see, for example, Non-patent Publication 1) is under investigation. These techniques and methods are, however, accompanied by one or more problems in that the resulting liquid preparations are insufficient in physical and chemical stability and/or they require very complex conditions for formulation.

Water-soluble cellulose derivatives, on the other hand, are extensively used as coating agents or binders upon producing tablets. As they form water-insoluble gels at high temperatures, they are also used as protecting agents for spices and the like which are prone to degradations in foods. For example, they are used to protect spices and the like having properties that they tend to degrade or to be lost during retort sterilization (see, for example, Patent Document 3), or to protect spices from being lost through heat processing in the course of the production of cooked foods, baked sweets or the like by coating the spices into coated powder with an edible, water-soluble additive or an edible, high-molecular substance (see, for example, Patent Document 4).

However, these techniques are not sufficient to resolve the problems of the unstability and unpleasant tastes of active ingredients, leading to an outstanding desire for the development of a liquid preparation which is excellent in the stability of an active ingredient, especially in the long-term storage stability of the active ingredient in a state that water exists, can mask an unpleasant taste, smell and the like, and permits prompt absorption of the active ingredient in the digestive tract after taking it.
Patent Document 1: JP-A-2000-038345
Patent Document 2: JP-A-2003-146880
Patent Document 3: U.S. Patent No. 6,056,992
Patent Document 4: JP-A-2002-320454
   Non-patent Document 1: M. Gallarate and three others “On the stability of ascorbic acid in emulsified systems for topical and cosmetic use”, International Journal of Pharmaceutics” 188, 233-241, 1999.

### DISCLOSURE OF THE INVENTION

Objects of the present invention are, therefore, to provide a liquid preparation in which the storage stability of an active ingredient has been improved and its unpleasant taste, smell and/or the like has been masked, and also a method for stabilizing an active ingredient in an aqueous solution.

With the foregoing circumstances in view, the present inventors have proceeded with extensive research to develop a method for inhibiting a contact of an active ingredient with an aqueous solution in a liquid preparation. As a result, it has been found that an active ingredient can be stably retained and at the same time, its unpleasant taste and/or smell can be masked when the active ingredient is coated with a water-soluble cellulose derivative and the thus-coated active ingredient is added to a solution the water content of which ranges from 10 to 80%, leading to the completion of the present invention.

Described specifically, the present invention provides a liquid preparation comprising a solution having a water content of from 10 to 80% and an active ingredient coated with a coating material which comprises a water-soluble cellulose derivative.

This invention also provides an encapsulated preparation with the liquid preparation filled therein.

This invention further provides a method for stabilizing an active ingredient in a liquid preparation, which comprises adding the active ingredient, which has been coated with a coating material comprising a water-soluble cellulose derivative, to a solution having a water content of from 10 to 80%.

According to the present invention, it is possible to provide a liquid preparation, which can stably retain a water-unstable active ingredient in the liquid preparation and at the same time, can mask its unpleasant taste and/or smell, and which permits prompt dissolution of the active ingredient in the digestive tract after the liquid preparation is taken. In addition, the liquid preparation according to the present invention can be filled in capsules, thereby making it possible to further improve the compliance.

### BRIEF DESCRIPTION OF THE DRAWINGS

FIG. 1 A diagram showing dissolution rates of an active ingredient from coating compositions in liquid preparations formulated in Examples and Comparative Examples.

### BEST MODES FOR CARRYING OUT THE INVENTION

The liquid preparation according to the present invention comprises a solution, which has a water content of from 10 to 80%, and an active ingredient coated with a coating material comprising a water-soluble cellulose derivative, and the method according to the present invention for stabilizing an active ingredient in a liquid preparation comprises adding the active ingredient, which has been coated with a coating material comprising a water-soluble cellulose derivative, to a solution having a water content of from 10 to 80%.

Although the content of water in the liquid preparation according to the present invention is from 10 to 80%, it can be preferably from 10 to 40%, more preferably from 10 to 30% from the standpoint of the stability of the active ingredient.

A water content higher than 80% is not preferred because the coating is dissolved to impair the stability. A water content lower than 10%, on the other hand, is not preferred either because such a liquid preparation is significantly increased in viscosity, is no longer provided with flow ability as a liquid property, and is hardly palatable.

The liquid preparation according to the present invention can be provided with still higher flow ability provided that its water activity is controlled to from 0.50 to 0.90, preferably from 0.65 to 0.90.

No particular limitation is imposed on the active ingredient coated with the coating material. For example, it may contain one or more of optional compounds or compositions such as drug, natural products, foods, crude drug extracts and fermented products. Preferably, the active ingredient may contain a water-unstable substance, a substance capable of causing an interaction with another ingredient, or a substance having an unpleasant taste such as bitterness, a sharp taste or astringency or an unpleasant smell. More preferably, the active ingredient may contain a water-unstable substance.

Specific examples of the active ingredient include vitamins such as vitamin B1 and its derivatives, vitamin B2 and its derivatives, niacin, vitamin B6 and its derivatives, vitamin B12 and its derivatives, vitamin C and its derivatives, vitamin E and its derivatives, pantothenic acid, biotin, folic acids, and pantothenyl alcohol; crude drug such as ginseng, garlic, licorice root, peony root, and Barren-worts; herbs such as blueberry, green tea, pepper, red pepper, and mentha herb; carboxylate esters such as aspirin, procaine, ethyl aminobenzoate, and atropine; penicillin and its derivatives, cephalosporin and its derivatives, and sulfides. Preferred examples are those unstable to water, such as vitamin B1 and its derivatives, vitamin E and its derivatives, vitamin B12 and its derivatives, vitamin C and its derivatives, aspirin, sulpyrine, procaine, chloramphenicol, sulpyrine, benzylpenicillin, nitrofurantoin, and cytarabine. With respect to each active ingredient which undergoes an interaction with another ingredient, one of the interacting ingredients can be coated, or both of them can be coated separately.

Along with the above-described active ingredient, one or more other ingredients, for example, one or more of sweeteners, sour agents, stabilizing agents, colorants, flavors and the like commonly usable in foods and medicinal products may be coated as needed.

The coating material which coats the above-described active ingredient contains a water-soluble cellulose derivative. The coating material can be prepared by dissolving the water-soluble cellulose derivative in water, alcohol, water-containing alcohol, or the like. In this case, the water-soluble cellulose derivative can be added, for example, in a proportion of from 8 to 30 wt. % based on the (granular, tablet-shaped, or powdery) active ingredient to be coated. One or more additives commonly employed in the manufacturing technology, for example, plasticizers, colorant, gelling agents, gelling aids, emulsifiers, dispersing agents, preservatives and the like can be added to the coating material.

Water-soluble cellulose derivative usable in the present invention can include gastric cellulose derivatives such as hydroxypropylmethylcellulose, methylcellulose, hydroxypropylcellulose, and hydroxyethylcellulose; and enteric cellulose derivatives such as hydroxypropylmethylcellulose phthalate, hydroxypropylmethylcellulose acetate succinate, carboxymethylcellulose, carboxymethylethylcellulose, cellulose acetate phthalate, and ethylcellulose. They can be used either singly or in combination, although preferred are hydroxypropylmethylcellulose, methylcellulose, hydroxypropylcellulose and hydroxyethylcellulose.

The plasticizers can include polyvinylacetal diethylaminoacetate, triethyl citrate, triacetylene, glycerin, D-sorbitol, polyethylene glycol, acetylated monoglycerides, organic acids (for example, citric acid, malic acid, lactic acid, etc.), calcium carbonate, and surfactants. They can be used either singly or in combination, although the use of one or more of triethyl citrate, citric acid and calcium carbonate is preferred.

The colorants can include caramel, sodium copper chlorophyllin, riboflavin sodium phosphate, indigocarmine, brilliant blue, tartrazine, sunset yellow, new coccine, amaranth, erythrosine, titanium oxide, and iron oxides. They can be used either singly or in combination.

The gelling agents can include carageenan, xanthan gum, locust beam gum, gellan gum, gum arabic, guar gum, tamarind seed polysaccharides, pectin, curdlan, gelatin, pharcellulan, and agar. They can be used either singly or in combination, although carageenan is preferred. The gelling agent can be added preferably in a proportion of from 0.1 to 5.0 wt. % based on the aqueous solution of the coating material.

The gelling aids can include water-soluble compounds capable of giving calcium ions, potassium ions, ammonium ions, sodium ions or magnesium ions, such as calcium chloride, potassium chloride, ammonium chloride, ammonium acetate, potassium phosphate, potassium citrate, sodium chloride and magnesium sulfate; and organic acids and their water-soluble salts such as citric acid and sodium citrate. They can be used either singly or in combination. The gelling aid can be added preferably in a proportion of from 0.01 to 1.0 wt. % based on the aqueous solution of the coating material.

As a coating method for the active ingredient making use of such a coating material, a conventional method, for example, spraying and drying, fluidized-bed coating, centrifugal coating or the like can be used. The active ingredient coated as described above can be in any one of tablet-shaped form, granular form and powdery form, with a powdery form being preferred for its good dispersibility. As an alternative, the active ingredient can also be in such a form that it is sealed in capsules made of the coating material.

The liquid preparation according to the present invention can be formulated by adding the thus-coated active ingredient to a solution having a water content of from 10 to 80%. In the liquid preparation, the active ingredient (coated particles) remains undissolved, and its state can be in any one of dispersed state, suspended state and mixed state.

In the liquid preparation according to the present invention, various medicinal ingredients usable in drug, quasi-drug, cosmetics, foods and the like can be incorporated in addition to the coated active ingredient. Examples of such ingredients include aqueous extracts of crude drug such as ginseng, garlic, Acanthopanax senticosus (Repr. et Maxim.) Harms, Japanese angelica root, rehmannia root, citrus unshiu peel, cuscuta seed, Schisandra fruit, and ophiopogon tuber; aqueous traditional Chinese medicine extracts such as kakkon-to (pueraria rood decoction), bakumonto-to (ophiopogon tuber decoction), shoseiryu-to, ourengedoku-to, shimotsu-to, and shakuyaku kanzo-to (peony root-glycyrrhiza decoction); aqueous extracts of animals or plants such as blueberry, green tea, herbs, and mushrooms; aqueous extracts of fermentation products obtained by fermenting cereals, plants or marine products with koji mold, ang-khak, lactic acid bacteria, acetic acid bacteria, natto bacteria, yeast or the like; aqueous solutions of vitamins, dextromethorphan hydrobromide, acetoaminophen, chlorophenylamine maleate, potassium guaiacolsulfonate, caffeine, dihydrocodeinephosphate, methylephedrine hydrochloride, and water-soluble azulene; and aqueous suspensions of aldioxa, magnesium hydroxide, sucralfate, magnesium metasilicate aluminate, and synthetic hydrotalcite. The term “aqueous extracts” as used herein means extraction products obtained by extracting crude drug, animals or plants, fermentation products or the like with water, water-containing alcohol or the like. Preferred are aqueous crude drug extracts or aqueous animal/plant extracts, which stably exist as aqueous solutions and can be formulated, as are, into preparations.

To the above-described liquid preparation, one or more of other ingredients, for example, sweeteners, sour agents, stabilizing agents, thickening agents, pH regulators, preservatives, colorants, flavors and the like generally usable in medicinal products and foods can be added as needed.

The sweeteners can include sugars such as sucrose, lactose, fructose and glucose; sugar alcohols such as sorbitol, erythritol, mannitol, xylitol, and trehalose; and glycyrrhizin, aspartame, and stevia. They can be used either singly or in combination.

The sour agents can include citric acid, malic acid, succinic acid, fumaric acid, tartaric acid, and lactic acid. They can be used either singly or in combination.

The stabilizing agents can include antioxidants such as ascorbic acid, erythorbic acid, and sodium pyrosulfite; dispersing agents such as sodium pyrophosphate, sodium polyphosphate, and sodium metaphosphate; surfactants such as sucrose fatty acid esters, polyoxyethylene hydrogenated castor oil, and polyoxyethylene polyoxypropylene glycol; cyclodextrins such as cyclodextrin, glucosylcyclodextrin, maltosylcyclodextrin, and hydroxypropylcyclodextrin; and electrolytes such as sodium chloride, magnesium chloride, and calcium chloride. They can be used either singly or in combination.

The thickening agents can include high-molecular substances such as dextrin, sodium alginate, propylene glycol alginate, tragacanth powder, xanthan gum, sodium carboxymethylcellulose, hydroxypropylcellulose, polyvinyl alcohol, and polyvinylpyrrolidone. They can be used either singly or in combination.

The pH regulators can include inorganic or organic acids such as hydrochloric acid, acetic acid, phosphoric acid, citric acid, malic acid, succinic acid, fumaric acid, tartaric acid and lactic acid, and their salts; and alkalis such as sodium hydroxide, potassium hydroxide, sodium hydrogencarbonate, and sodium dihydrogenphosphate. They can be used either singly or in combination.

The preservatives can include benzoic acid and its derivatives, sorbic acid and its derivatives, paraoxybenzoate esters and their derivatives, and salicylic acid and its derivatives. They can be used either singly or in combination.

The colorants can include caramel, sodium copper chlorophyllin, riboflavin sodium phosphate, indigocarmine, brilliant blue, tartrazine, sunset yellow, new coccine, amaranth, and erythrosine. They can be used either singly or in combination.

The flavors can include funnel oil, orange oil, cinnamon oil, bitter orange peel oil, pennyroyal oil, and eucalyptus oil, and natural flavors or fragrances each prepared by using one or more of these oils as raw material(s) can also be used.

The liquid preparation according to the present invention can also be formed into an encapsulated preparation by filling an adequate amount of the liquid preparation in capsules. In this case, the composition employed to coat the active ingredient can be in a form mixed beforehand in the liquid preparation or in a form filled in capsules. The encapsulated preparation can be formed as soft elastic capsules or hard capsules in which one or more water-soluble ingredients can be filled, although preferred are hard capsules with a water-soluble cellulose derivative contained therein.

The package form of the liquid preparation can be a commonly-used form, for example, bottling, divided packaging in aluminum foil wraps, or PTP (press through package). The encapsulated preparation, on the other hand, can be formed using a conventionally-employed liquid drug filling machine for oily substances or a granule filling machine.

As a preferred embodiment of the liquid preparation according to the present invention, a vitamin or a derivative thereof can be coated as an example with a hydroxypropylmethylcellulose-containing coating material into a granular form or powdery form, and can then be added to a liquid preparation containing a crude drug extract and having a water content of from 10 to 40% and a water activity of from 0.50 to 0.90. Preferred is one filled in a bottle, one dividedly packaged in aluminum foil wraps, or one packaged by PTP.

### EXAMPLE

The present invention will hereinafter be described in further detail on the basis of Examples. It is, however, to be noted that the present invention is not limited to the following Examples.

### Example 1

| | | |
|---|---|---|
| Thiamine hydrochloride | 1,000 | g |
| Avicel | 1,925 | g |
| Lactose | 1,300 | g |
| L-HPC | 650 | g |
| HPC-SL | 100 | g |
| Magnesium stearate | 25 | g |

In accordance with the above formulation, a non-coated composition of 6 mm in diameter was prepared. An 8% aqueous solution of hydroxypropylmethylcellulose was sprayed against the composition, followed by drying to coat the composition with hydroxypropylmethylcellulose in an amount equivalent to 8% based on the weight of the composition. The coated composition was added to a crude drug extract having a water content of 31% and a water activity of 0.670. After the thus-obtained liquid preparation was filled in a glass bottle, the glass bottle was sealed and then stored at 40° C. for 1 month. As a result of an HPLC measurement of the content of thiamine hydrochloride in the stored sample, the content was determined to be 101.1% based on the initial value so that no lowering was confirmed at all. Further, the coating had not been dissolved, and no changes were acknowledged in the properties of the liquid preparation.

### Example 2

An aqueous solution containing 5.6% of hydroxypropylmethylcellulose and 2.4% of polyvinylacetal diethylaminoacetate was sprayed against an uncoated composition of the formulation of Example 1, followed by drying to coat the composition with hydroxypropylmethylcellulose and polyvinylacetal diethylaminoacetate in an amount equivalent to 8% based on the weight of the composition. The coated composition was added to a crude drug extract having a water content of 31% and a water activity of 0.670. After the thus-obtained liquid preparation was filled in a glass bottle, the glass bottle was sealed and then stored at 40° C. for 1 month. As a result of an HPLC measurement of the content of thiamine hydrochloride in the stored sample, the content was determined to be 100.0% based on the initial value so that no lowering was confirmed at all. Further, the coating had not been dissolved, and no changes were acknowledged in the properties of the liquid preparation.

### Example 3

| | | |
|---|---|---|
| Thiamine hydrochloride | 150 | g |
| Avicel | 600 | g |
| Lactose | 495 | g |
| L-HPC | 225 | g |
| HPC-SL | 30 | g |

A granular composition of 1.2 mm in diameter was prepared by conducting mixing and kneading in accordance with the above formulation and then performing extrusion and granulation. A solution with 5% of hydroxypropylmethylcellulose contained in 10% ethanol was sprayed against the granular composition, followed by drying to coat the composition with hydroxypropylmethylcellulose in an amount equivalent to 8% based on the weight of the composition. The coated composition was added to a crude drug extract having a water content of 31% and a water activity of 0.670. After the thus-obtained liquid preparation was filled in a glass bottle, the glass bottle was sealed and then stored at 40° C. for 3 months. As a result of an HPLC measurement of the content of thiamine hydrochloride in the stored sample, the content was determined to be 83.7% based on the initial value. Further, the coating had not been dissolved, and no changes were acknowledged in the properties of the liquid preparation.

### Example 4

| | | |
|---|---|---|
| Thiamine hydrochloride | 300 | g |
| Avicel | 585 | g |
| Lactose | 390 | g |
| L-HPC | 195 | g |
| HPC-SL | 30 | g |

A granular composition of 0.5 mm in diameter was prepared by conducting mixing and kneading in accordance with the above formulation and then performing extrusion and granulation. A solution with 8% of hydroxypropylmethylcellulose and 1% of triethyl citrate dissolved in 10% ethanol was sprayed against the granular composition, followed by drying to coat the composition with hydroxypropylmethylcellulose and triethyl citrate in an amount equivalent to 30% based on the weight of the composition so that a coated composition was obtained. The coated composition was added to a crude drug extract having a water content of 31% and a water activity of 0.670. After the thus-obtained liquid preparation was filled in a glass bottle, the glass bottle was sealed and then stored at 40° C. for 3 months. As a result of an HPLC measurement of the content of thiamine hydrochloride in the stored sample, the content was determined to be 81.5% based on the initial value. Further, the coating had not been dissolved, and no changes were acknowledged in the properties of the liquid preparation.

### Example 5

A granular composition of 0.5 mm in diameter was prepared by conducting mixing and kneading in accordance with the formulation of Example 4 and then performing extrusion and granulation. A solution with 8% of hydroxypropylmethylcellulose, 1.8% of citric acid and 0.7% of calcium carbonate contained in water was sprayed against the granular composition, followed by drying to coat the composition with hydroxypropylmethylcellulose, citric acid and calcium carbonate in an amount equivalent to 20% based on the weight of the composition so that a coated composition was obtained. The coated composition was added to a crude drug extract having a water content of 33% and a water activity of 0.685. After the thus-obtained liquid preparation was filled in a glass bottle, the glass bottle was sealed and then stored at 40° C. for 1 month. As a result of an HPLC measurement of the content of thiamine hydrochloride in the stored sample, the content was determined to be 96.0% based on the initial value. Further, the coating material had not been dissolved, and no changes were acknowledged in the properties of the liquid preparation.

### Example 6

Thiamine hydrochloride was filled in a No. 2 capsule made of hydroxypropylmethylcellulose. After the capsule was sealed at a joint thereof with a 50% solution of hydroxypropylmethylcellulose in ethanol, the sealed capsule was immersed in a crude drug extract having a water content of 30% and a water activity of 0.658. After the thus-obtained liquid preparation was filled in a glass bottle, the glass bottle was sealed and then stored at 40° C. for 3 months. As a result of an HPLC measurement of the content of thiamine hydrochloride in the stored capsule, the content was determined to be 98.7% based on the initial value. Further, the encapsulated preparation had not been dissolved, and no changes were acknowledged in the properties of the liquid preparation.

### Comparative Example 1

A composition prepared in accordance with the formulation of Example 1 was added in an uncoated state to a crude drug extract having a water content of 31% and a water activity of 0.670. After the thus-obtained liquid preparation was filled in a glass bottle, the glass bottle was sealed and then stored at 40° C. for 1 month. As a result of an HPLC measurement of the content of thiamine hydrochloride in the stored sample, the content was determined to be 64.9% based on the initial value. At that time, the composition had disintegrated and did not retain its shape.

### Comparative Example 2

An uncoated, granular composition of 0.5 mm in diameter prepared in accordance with the formulation of Example 3 was added to a crude drug extract having a water content of 31% and a water activity of 0.670. After the thus-obtained liquid preparation was filled in a glass bottle, the glass bottle was sealed and then stored at 40° C. for 3 months. As a result of an HPLC measurement of the content of thiamine hydrochloride in the stored sample, the content was determined to be 38.4% based on the initial value. At that time, the composition had disintegrated and was dispersed as fine particles.

### Example 7

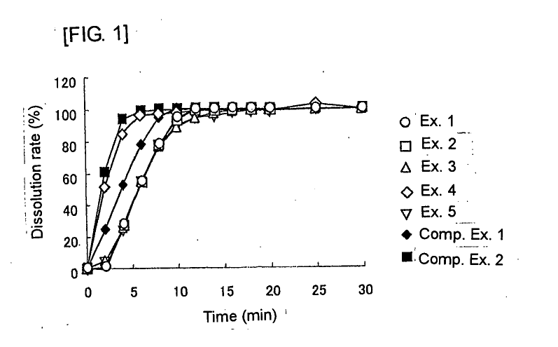

The solubilities of the active ingredient in the compositions coated with the water-soluble cellulose derivative and added in the liquid preparations according to the present invention were determined. Specifically, with respect to the coated composition prepared in Examples 1, 2, 3, 4 and 5 and the uncoated compositions prepared in Comparative Examples 1 and 2, a dissolution test was conducted under the following solvent and temperature conditions: water and 37° C. As a result, as shown in FIG. 1, the coated composition were all dissolved in 15 minutes although they had a lag time.

As a consequence, it has been found that in the liquid preparation according to the present invention, the active ingredient dissolves promptly upon ingestion.

1. A liquid preparation comprising a solution, which has a water content of from 10 to 80%, and an active ingredient coated with a coating material comprising a water-soluble cellulose derivative.

2. The liquid preparation according to claim 1, which has a water activity of from 0.50 to 0.90.

3. The liquid preparation according to claim 1 or 2, wherein said water-soluble cellulose derivative comprises one or more water-soluble cellulose derivatives selected from the group consisting of hydroxypropylmethylcellulose, methylcellulose, hydroxypropylcellulose and hydroxyethylcellulose.

4. The liquid preparation according to any one of claims 1-3, wherein said active ingredient comprises a water-unstable substance.

5. The liquid preparation according to any one of claims 1-4, wherein said solution comprises an aqueous crude drug extract and/or an aqueous animal/plant extract.

6. An encapsulated preparation with a liquid preparation according to claims 1-5 filled therein.

7. The encapsulated preparation according to claim 6, comprising a hard capsule as a capsule.

8. A method for stabilizing an active ingredient in a liquid preparation, which comprises adding said active ingredient, which has been coated with a coating material comprising a water-soluble cellulose derivative, to a solution having a water content of from 10 to 80%.

9. The method according to claim 8, wherein said liquid preparation has a water activity of from 0.50 to 0.90.

10. The method according to claim 8 or 9, wherein said water-soluble cellulose derivative comprises one or more water-soluble cellulose derivatives selected from the group consisting of hydroxypropylmethylcellulose, methylcellulose, hydroxypropylcellulose and hydroxyethylcellulose.
